(19) United States
(12) Patent Application Publication
(10) Pub. No.: US 2023/0095636 A1
(43) Pub. Date: Mar. 30, 2023

(54) RESTAURANT SERVICE ROBOT

(71) Applicant: RGT Inc., Daejeon (KR)

(72) Inventor: Ho Jeong JEONG, Daejeon (KR)

(73) Assignee: RGT Inc., Daejeon (KR)

(21) Appl. No.: 17/802,527

(22) PCT Filed: Sep. 17, 2020
(86) PCT No.: PCT/KR2020/012555

§ 371 Date: Aug. 26, 2022

(30) Foreign Application Priority Data
Jul. 22, 2020 (KR) 10-2020-0091104

(51) Int. Cl. B65G 1/04; G05D 1/02; G09F 19/18

(52) U.S. Cl. CPC B65G 1/0485; G05D 1/0231; G09F 19/18

(57) ABSTRACT

A restaurant service robot moves to a target table along a movement path in a state in which a plurality of trays, on which food can be placed, are arranged to be vertically spaced a predetermined distance apart from each other to form a multi-layer structure and food is accommodated on the trays, so as to induce, through a voice or a display, a customer to take the food. The restaurant service robot comprises a communication function unit, an image receiving unit, a path search unit, one or more tray seating units, an information display unit, and an external input unit.

### TECHNICAL FIELD

The present invention relates to a restaurant service robot and, more specifically, to a restaurant service robot, which moves to a target table along a movement path in a state in which a plurality of trays, on which food can be placed, is arranged to be vertically spaced apart at a predetermined distance from each other to form a multi-layer structure and food is accommodated on the trays, so as to induce, through a voice, a display, or a touch sensor a customer to take the food.

### BACKGROUND ART

In case of the companies such as a restaurant etc., that provide services, as employees work, the problem of service response is emerged, and the introduction of a 52-hour workweek and the increase in the minimum wage are in progress, increasing the burden of labor costs. Accordingly, the unmanned service market that does not employ employees has been rapidly expanded.

In particular, a KIOSK, which is an unmanned information guide system for providing unmanned orders and payments, is actively used by the service companies.

However, in a case of the service that provides foods or drinks completed through a cooking or a processing, the development of the unmanned technology is insufficient.

As such, there is a continuous demand for the development of a technology for enabling unmanned service to be provided not only in the order and payment described above, but also in relation to the serving of delivering the finished food to the customer.

In the meantime, an intelligent robot technology has been actively developed for various reasons such as a replacement of a labor cost, a response to aging, an enhancement of industrial competitiveness, and a strengthening of national defense capabilities and so on.

Although a robot is generally used in the industries such as a medicine, an agriculture, a safety, and a marine, the development of the serving robot for serving in restaurants is lagging behind.

Currently, in the case of the serving robot, the research and development has been carried out in earnest since 2017 and various services are introduced into the serving robot.

However, since the technology for providing various additional services is still insufficient, various technologies for service convenience are required.

### PATENT LITERATURE

Patent Literature 1: Korean Patent Publication No. 10-2001-0106845

### Disclosure

### Technical Problem

In this respect, the present invention is made to solve the above-described problem in the related art, and an object thereof is to provide a restaurant service robot, which moves to a target table along a movement path in a state in which a plurality of trays, on which food can be placed, is arranged to be vertically spaced apart at a predetermined distance from each other to form a multi-layer structure and food is accommodated on the trays, so as to induce, through a voice or a display, a customer to take the food.

Another object of the present invention is to provide a restaurant service robot capable of providing effects such as machine stability, customer convenience, kitchen workability, appearance demonstration, etc. by providing the position from the floor to the tray in a range of 55 centimeters to 120 centimeters in the case of the tray seating unit configured in the serving robot.

### Technical Solution

According to one aspect of the present invention so as to accomplish these objects, there is provided to a restaurant service robot, including:

a communication function unit (110) for connecting to communicate with nearby Wi-Fi or Bluetooth;

an image receiving unit (120) for receiving an image of a closed circuit through the communication function unit to search for a traveling path;

a path search unit (130) that configures a movement path for distinguishing a dining table from a passage by extracting an outline of the received image to travel in the restaurant;

one or more tray seating units (140) configured to be installed on the robot;

an information display unit (150) positioned at an upper end of the robot to display information; and

an external input unit (160) for receiving an external input by configuring a touch sensor in the information display unit of the robot or by installing a button near the information display unit of the robot.

In the meantime, according to another aspect of the present invention so as to accomplish these objects, there is provided to a restaurant service robot, including:

tray seating units (140) having a multi-layer structure, which is spaced apart from each other at a predetermined distance to accommodate food; and

a control unit (200) for generating a control signal for moving the restaurant service robot to a target table;

a driving unit (300) for moving the serving robot based on the control signal; and

an output unit (400) that operates to deliver the food to the target table, wherein a plurality of the tray seating units (140) is arranged to be spaced apart from each other at a predetermined distance within the range of 55 centimeters to 120 centimeters from the floor to the tray.

### Advantageous Effects

The present invention provides the restaurant service robot, which moves to a target table along a movement path in a state in which a plurality of trays, on which food can be placed, is arranged to be vertically spaced a predetermined distance apart from each other to form a multi-layer structure and food is accommodated on the trays, so as to induce, through a voice or a display, a customer to take the food, and thus unmanned general restaurants are possible, and a labor cost saving effect, a service quality improvement effect, and the like are provided.

### BRIEF DESCRIPTION OF DRAWINGS

The above and other objects, features and advantages of the present invention will be more apparent from the following detailed description taken in conjunction with the accompanying drawings, in which:

FIG. 1 is a perspective view of a restaurant service robot according to an embodiment of the present invention;

FIG. 2 is a perspective view of a restaurant service robot viewed from another angle according to an embodiment of the present invention;

FIG. 3A and FIG. 3B are exemplary views illustrating a front and a rear of the restaurant service robot according to an embodiment of the present invention;

FIG. 4 is a side view of a restaurant service robot according to an embodiment of the present invention;

FIG. 5 is a plan view of a restaurant service robot according to an embodiment of the present invention;

FIG. 6 is a bottom view of a restaurant service robot according to an embodiment of the present invention;

FIG. 7 to FIG. 8 are exemplary views illustrating a state of outputting a serving completion signal from an information display unit (150) of the restaurant service robot according to an embodiment of the present invention;

FIG. 9 is an exemplary diagram illustrating a state in which a menu for ordering is provided in an information display unit (150) of a restaurant service robot according to an embodiment of the present invention;

FIG. 10 is an exemplary view illustrating a state in which an additional housing and an additional module are further included in a restaurant service robot according to an embodiment of the present invention;

FIG. 11 is an exemplary view illustrating a state in which a plurality of tray seating units is formed at an optimal height in a restaurant service robot according to an embodiment of the present invention;

FIG. 12 is an exemplary view illustrating a state in which a hologram display unit (170) is formed in a restaurant service robot according to an embodiment of the present invention;

FIG. 13 is a graph illustrating points according to a height of a tray for selecting the optimal height of a tray seating unit, which is mounted on a restaurant service robot according to an embodiment of the present invention; and

FIG. 14 is a block diagram illustrating a control system of a restaurant service robot according to an embodiment of the present invention.

### REFERENCE SIGNS LIST

200: control unit
300: driving unit
400: output unit

### BEST MODE

### Mode for Invention

Terms used in this specification will be briefly described, and the present invention will be described in detail.

The terms used in the present invention have been selected as currently widely used general terms as possible while considering the functions in the present invention, but these may vary depending on the intention or precedent of a person skilled in the art, the emergence of new technology, and the like.

In addition, in a specific case, there is a term arbitrarily selected by the applicant, and in this case, the meaning will be described in detail in the description of the corresponding invention.

Therefore, the term used in the present invention should be defined based on the meaning of the term and the overall content of the present invention, rather than the name of a simple term.

When a part “includes” a component throughout the specification, this means that other components may be further included, rather than excluding other components, unless otherwise stated.

In addition, terms such as “unit” and “module” described in the specification mean a unit for processing at least one function or operation, which may be implemented as hardware or software, or a combination of hardware and software.

In addition, when a certain part is said to be “connected” with another part throughout the specification, this includes not only the case where it is “directly connected” but also the case where it is connected “with another configuration in the middle”.

Hereinafter, embodiments of the present invention will be described in detail with reference to the accompanying drawings so that those of ordinary skill in the art can easily carry out the present invention.

However, the present invention may be embodied in various different forms and is not limited to the embodiments described herein.

Also, in order to clearly explain the present invention in the drawings, parts irrelevant to the description are omitted.

Hereinafter, the configuration of the restaurant service robot according to the present invention will be described in detail with reference to the accompanying drawings.

In other words, the restaurant service robot according to the present invention includes:

a communication function unit (110) for connecting to communicate with nearby Wi-Fi or Bluetooth;

an image receiving unit (120) for receiving an image of a closed circuit through the communication function unit to search for a traveling path;

a path search unit (130) that configures a movement path for distinguishing a dining table from a passage by extracting an outline of the received image to travel in the restaurant;

one or more tray seating units (140) configured to be installed on the robot;

an information display unit (150) positioned at an upper end of the robot to display information; and

an external input unit (160) for receiving an external input by configuring a touch sensor in the information display unit of the robot or by installing a button near the information display unit of the robot.

At this time, in the tray seating units (140), it is characterized in that the position (height) of the tray from the floor to the tray (tray seating unit) is 55 centimeters to 120 centimeters.

On the other hand, the restaurant service robot according to another embodiment of the present invention includes:

tray seating units (140) having a multi-layer structure, which is spaced apart from each other at a predetermined distance to accommodate food; and

a control unit (200) for generating a control signal for moving the restaurant service robot to a target table;

a driving unit (300) for moving the serving robot based on the control signal; and

an output unit (400) that operates to deliver the food to the target table,

wherein a plurality of the tray seating units (140) is arranged to be spaced apart from each other at a predetermined distance within the range of 55 centimeters to 120 centimeters from the floor to the tray.

At this time, according to further another embodiment of the present invention, it is characterized in that the restaurant service robot further includes a hologram display unit (170) that can display the promotional video play as a hologram.

At this time, it is characterized in that the external input unit also includes a touch pad.

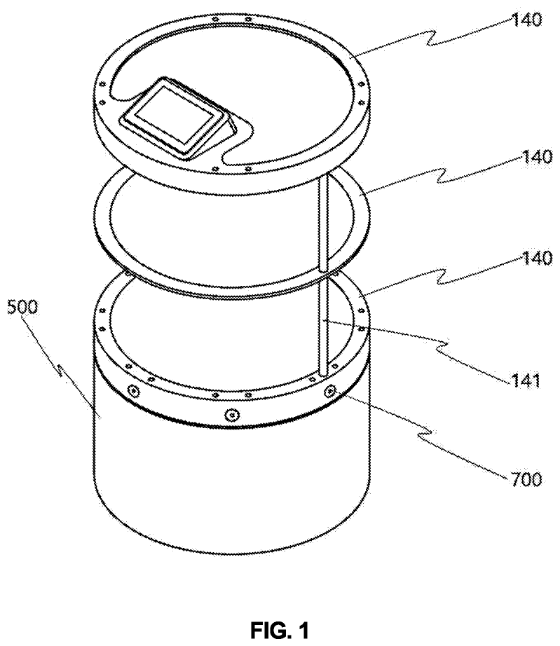

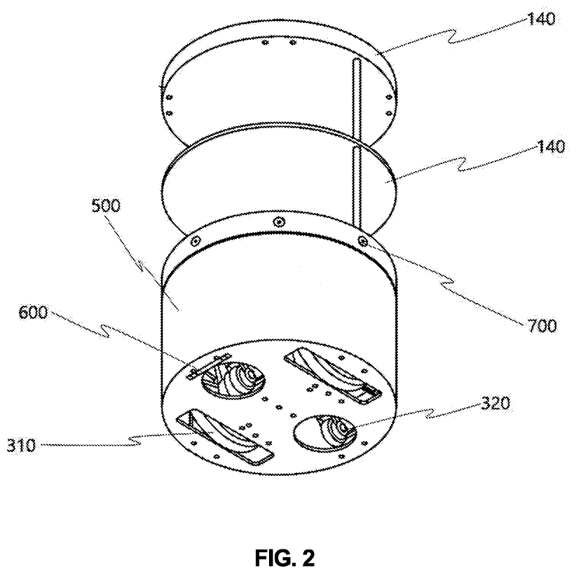

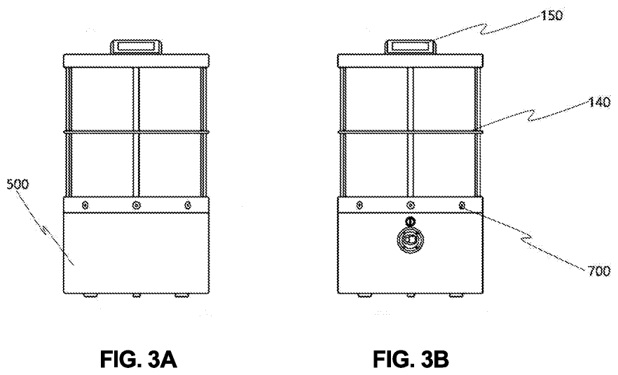

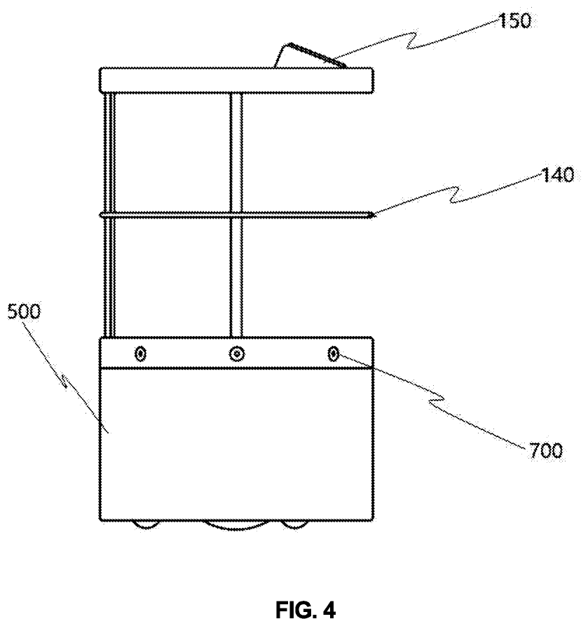

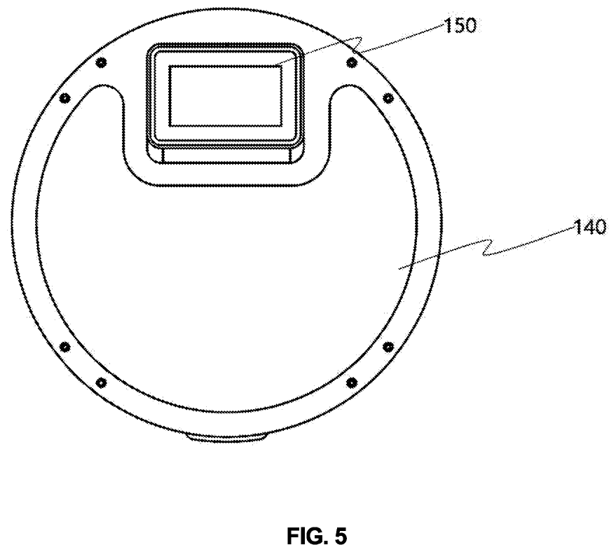

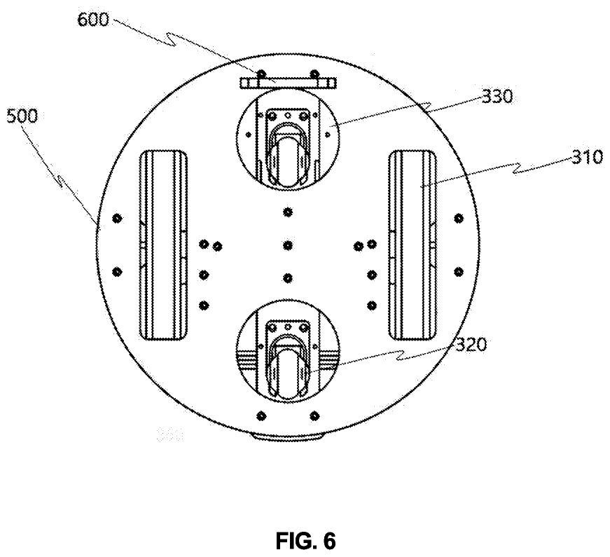

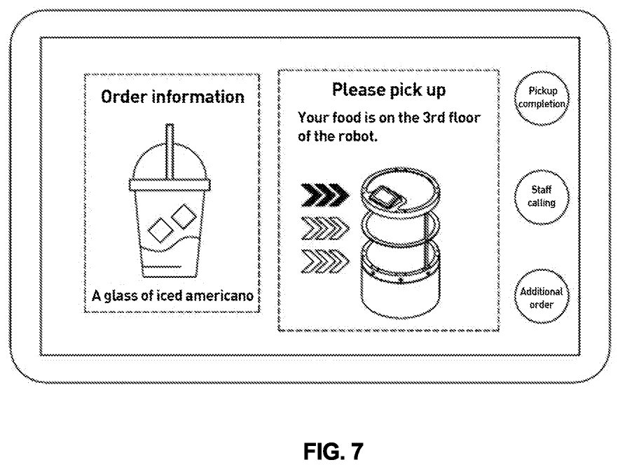

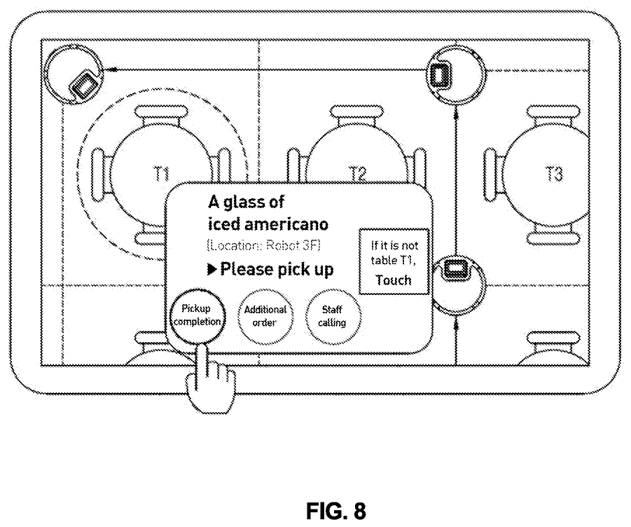

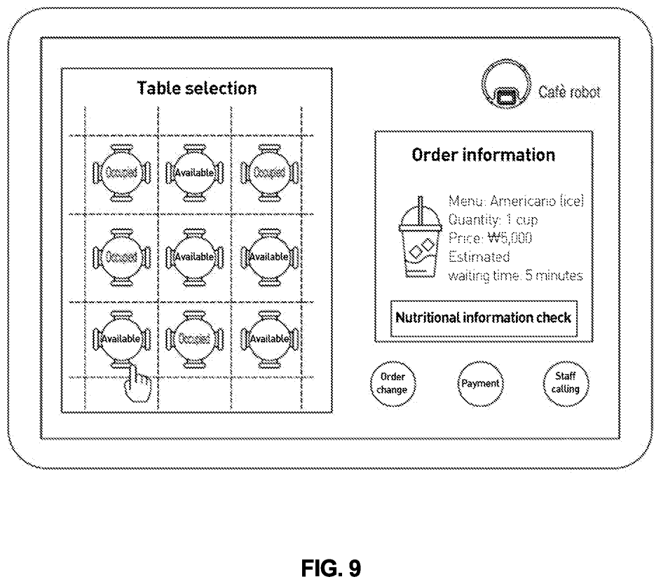

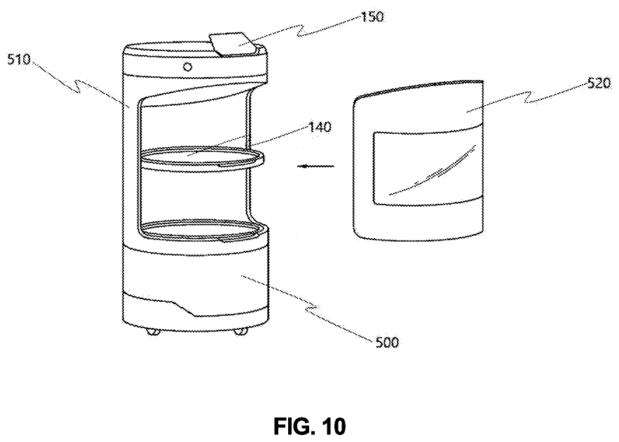

FIG. 1 is an overall configuration diagram of a restaurant service robot according to an embodiment of the present invention.

As shown in FIG. 1, the restaurant service robot according to the present invention includes tray seating units (140) for accommodating food, a control unit (200) for controlling the serving robot, a driving unit (300) for moving the serving robot, and an output unit (400) that performs an operation for delivering the food to the target table.

One or more tray seating units (140) are installed and arranged to be spaced apart from each other at a predetermined distance to form a multi-layer structure.

Accordingly, the food is placed on the upper surface of the tray seating unit.

The control unit (200) is in charge of overall control of the serving robot, for example, generates a control signal for moving the serving robot to the target table.

Also, when the serving robot arrives at the target table, the control unit (200) outputs a serving completion signal and transmits it to the output unit (400).

The driving unit (300) moves the serving robot when it acquires the control signal of the control unit (200), and then, the output unit (400) operates based on the serving completion signal.

In a state in which the serving robot arrives at the target table, the output unit acquires the serving completion signal, and informs the customer that the ordered food has been brought to the target table in order to deliver the food accommodated in the tray seating unit to the target table.

For example, the customer may sense a visual and/or an audible signal and/or an operation generated by the output unit according to the serving completion signal and may move the food to the target table.

A plurality of tray seating units (140) of the serving robot according to an embodiment of the present invention is formed in a multi-layer structure.

The food can be accommodated on each tray seating unit as shown in FIG. 1, that is, three trays (tray seating units) are provided and the receiving unit thereof is formed in a three-layer structure. However, as shown in other drawings, it is obvious that the trays (tray seating units) may be formed in two-layer or in a multi-layer structure of four or more layers.

In addition, although it is exemplified that the tray seating unit has a disk shape in one embodiment, it may be formed in various shapes such as a disk shape and a square shape etc.

In addition, the plurality of tray seating units may be formed in different shapes. For example, as shown in the drawings, the thickness of each tray seating unit may be formed to be different.

However, it is preferable that all of the tray seating units is formed in a flat shape so that the food, which is placed on the top surface thereof, can be transferred to the customer's table without being shaken.

The plurality of tray seating units may be connected through at least one or more pillars (141). In one embodiment of the present invention, the plurality of tray seating units is connected to each other through three pillars.

The three pillars (141) are disposed on the left, right, and rear of the tray seating units (140), so that the upper space of the tray seating units (140) is open to the front.

On the other hand, as described above, the control unit (200) of the serving robot according to an embodiment of the present invention serves to control the overall operation, that is, generates the driving unit control signal for moving the serving robot to the target table and generates the serving completion signal when the serving robot reaches the target table.

For example, as shown in the drawing, the control unit (200) may control the operation the driving unit (300), the output unit (400), a power supply unit, the communication function unit (110), the image receiving unit (120), the path search unit (130), the information display unit (150), and the external input unit (160) and so on.

The driving unit control signal of the control unit (200) may be a signal for controlling the operation of the driving unit (300) so that the serving robot moves to the target table.

The driving unit control signal may be signals, which are generated based on information related to the movement thereof such as a movement path, a movement speed, and a departure time for the serving robot to move from a starting point (for example, a kitchen) to a destination (for example, a target table).

The target table is a table to which food ordered by an orderer (for example, a customer) is provided. Also, the target table may refer not only to a simple table, but also to a place reserved by the orderer or for providing the corresponding service.

In addition, the serving completion signal is a control signal that causes the output unit (400) to operate to notify the orderer that the serving is completed.

The output unit (400) performs an alarm function to notify the orderer that the ordered food has arrived at the target table based on the serving completion signal.

That is, when the serving robot completes the movement to the target table while accommodating the food and the food arrives at the target table, the output unit (400) informs the customer of the fact that the food has arrived and the position of the food (the position of the food on the corresponding tray seating unit).

Such a notification may include a visual notification using the information display unit (150), an audible notification using a speaker, and/or a visual notification using an LED module.

The driving unit (300) described in the present invention may include a power supply unit for generating a driving force, at least one steering unit for changing the direction of the serving robot, and at least one transfer unit for driving the serving robot according to the driving force.

A housing (500) is provided at a lower portion of the tray seating unit of the lowest layer among the plurality of tray seating units and the steering unit and the transfer unit for moving the serving robot in contact with the floor may be disposed at the lower end portion of the housing.

At this time, it is not limited to the kinds of the driving force generated through the power supply unit. For example, the driving force may be a rotational force or a linear movement force.

In addition, there is no limitation in the method of the power supply unit of generating the driving force. For example, the power supply unit may include an electric motor, a compressor, and the like.

The steering unit serves to change the direction of the serving robot and the transfer unit serves to drive the serving robot.

The steering unit and the transfer unit may be provided as separate wheels. Also, it may be integrally provided on the same wheel as in the embodiment of the present invention.

Referring to the drawings, in the embodiment of the present invention, two driving wheels (310), which is disposed on the left and right thereof form the steering unit and the transfer unit.

Each of the two driving wheels may be an in wheel motor in which a rotation direction and a rotation speed are independently controlled.

When the two driving wheels rotate in the same direction at the same rotational speed, the serving robot can move forward or backward.

In addition, when the two driving wheels rotate in opposite directions at the same rotational speed, the serving robot can rotate in place.

In addition, if the two driving wheels rotate in the same direction but have different rotational speeds, the serving robot may move in a curved trajectory.

The idler wheels (320) are arranged back and forth so that the serving robot can stably stand on the floor and the idler wheel rotates about a predetermined horizontal axis.

In addition, the idler wheels are provided on the lower surface of the housing (500) and the viewing direction may be changed around a predetermined vertical axis passing through the center of a receiving hole for accommodating the idler wheel.

Accordingly, the idler wheel may follow the moving direction of the serving robot and the direction thereof may be aligned around the vertical axis.

However, the number and arrangement of the driving wheel and the idler wheel are not limited to the above-described structures and the structures of the steering unit and the transfer unit are not limited thereto.

That is, it is a self-evident fact that the steering unit and the transfer unit may each be configured as separate wheels.

In addition, the housing (500) may be provided under the serving robot. As shown in the drawing, the serving robot may be provided with a receiving unit including a first tray seating unit, a second tray seating unit, and a third tray seating unit.

The housing may be configured in a form connected to the third tray seating unit corresponding to the lowermost tray seating unit among the plurality of tray seating units and the housing may be integrally formed with the lowermost tray seating unit.

Meanwhile, the output unit of the serving robot according to an embodiment of the present invention may further include the speaker module, the LED module, and the information display unit (150) for notifying a customer that the serving is completed.

The speaker module may be disposed at a predetermined position of the serving robot. For example, the speaker module may be provided for each layer of the receiving unit of the multi-layer structure provided with the plurality of tray seating units (140), or it may be provided on the tray seating unit (140) together with the information display unit (150), or it may be provided in the housing (500).

The speaker module may convert the serving completion signal into voice data and provide it to the orderer located in the target table. In addition, it may provide voice data related to the serving as well as voice data for ordering and payment to the orderer.

In the meantime, order information and pickup information of foods cooked according to the corresponding order may be displayed on the screen of the information display unit.

That is, the order information regarding the food ordered by the orderer may be displayed. For example, the food ordered by the orderer is displayed as “a glass of iced americano” on the information display unit (250). Accordingly, the orderer can check the displayed order information.

Also, the pickup information related to the location of the ordered food may be displayed on the information display unit (150) of the serving robot.

Similarly, the orderer can confirm through the information display unit (150) that the ordered “a cup of iced americano” is placed on the third floor of the serving robot provided with the receiving unit of the three-layer structure.

In particular, first and second arrows having different shapes, types and/or colors may be additionally displayed on the information display unit (150) so that the orderer can intuitively understand them.

For example, when the food ordered by the orderer arrives at the target table where the orderer is located, the tray seating unit on which the ordered food is placed may be indicated by a first arrow. At this time, the remaining tray seating units may be indicated by the second arrow.

The first arrow and the second arrow may have different shapes or display in different colors. In addition, any one of the first arrow and the second arrow, for example, only the first arrow may be displayed in a blinking form on the screen of the information display unit (250).

Additionally, the serving robot may further include an external input unit (160) capable of applying a pickup completion signal.

The external input unit (160) may be implemented as a touch input of a pickup completion mark displayed on the information display unit.

The orderer may input the pickup completion signal to the control unit of the serving robot by applying the pickup completion signal through the touch of the pickup completion mark.

That is, a signal of confirming that the food ordered by the orderer has been taken from the serving robot through the pickup completion signal, which is inputted by the orderer, may be provided to the serving robot.

In addition, the serving robot may further include a second input unit capable of applying a staff calling signal.

The second input unit may be implemented as a touch input of a staff calling mark displayed on the information display unit.

The orderer can input the staff calling signal to the control unit of the serving robot by touching the staff calling mark. For example, in order to call the staff in case there is a problem in serving due to an error in a specific operation of the serving robot, the staff calling signal may be input to the serving robot by means of the orderer.

In addition, the serving robot may further include a third input unit capable of applying an additional order signal of food. At this time, the third input unit may be implemented as a touch input of the additional order mark displayed on the information display unit.

The orderer may input the additional order signal to the control unit of the serving robot by touching the additional order mark.

If the orderer wants to modify the existing order information or order additional food, he may input an additional order signal by touching the additional order mark displayed on the information display unit.

According to the input of the additional order signal, a screen for ordering may be displayed on the information display unit of the serving robot.

In summary, the signals such as the pickup completion signal, the staff calling signal, and the additional order signal, that can be input to the serving robot by the orderer, may be applied through a touch operation of the information display unit.

In addition, the orderer maintains the serving robot in a voice input standby state through the orderers trigger voice signal, and then, the pickup completion signal, the staff calling signal, and the additional order signal, etc. may be input to the serving robot through the orderers voice signal.

To this end, the serving robot may further include a microphone for voice input.

In addition, the serving robot may provide the order information and the pickup information to the orderer through the screen of the information display unit etc.

Additionally, a map, on which the location of the target table where the orderer is located is displayed, may be output through the information display unit.

As such, in order to check the error that may occur in the movement of the serving robot, the table position of the orderer may be displayed on the information display unit.

In addition, a table confirmation mark may be additionally displayed on the information display unit.

If the orderer confirms that the table reached by the serving robot is not the target table, the orderer may touch the table confirmation mark to input a table mismatch signal thereon.

For example, if the table reached by the serving robot is “Table T2” instead of “Table T1”, which is the target table, the serving robot is not moved to the correct place. Accordingly, the orderer can input the table mismatch signal so that the serving robot returns to the starting point or finds the correct target table and moves again.

That is, the serving robot may further include a fourth input unit capable of applying the table mismatch signal, which may be implemented as a touch input of the table confirmation mark displayed on the information display unit.

In addition, a movement path of the serving robot may be additionally displayed.

By checking the movement path, the orderer can easily determine whether the serving robot has arrived at the correct target location.

On the other hand, according to an additional aspect of the present invention, the serving robot,

a communication function unit (110) for connecting to communicate with nearby Wi-Fi or Bluetooth;

an image receiving unit (120) for receiving an image of a closed circuit through the communication function unit to search for a traveling path; and

a path search unit (130) that configures a movement path for distinguishing a dining table from a passage by extracting an outline of the received image to travel in the restaurant.

That is, the image of the closed circuit is received through the image receiving unit (120) by using the communication function unit that utilizes nearby Wi-Fi or Bluetooth communication method in order to search for the traveling path.

In this case, the path search unit (130) extracts the outline of the received image to travel in the inside of the restaurant to distinguish the dining table from the passage to configure the movement path.

Accordingly, the movement path of the serving robot is determined using the passage movement path and the serving robot can be moved to the desired target table by moving along the corresponding movement path.

In the meantime, the serving robot according to another embodiment of the present invention may move along a track provided in advance.

To this end, the serving robot may include a first sensor unit (600) for detecting the track.

The serving robot may be moved by detecting the track based on a line tracing algorithm.

For example, the track may be a magnetic tape attached to the floor and the first sensor unit may be a magnetic detection sensor that detects a magnetic force of the magnetic tape.

The magnetic detection sensor of the first sensor unit may be disposed in a predetermined shape on the lower surface of the housing.

As another example, the first sensor unit may include a light emitting unit for irradiating light to the track and a light receiving unit for sensing the light reflected from the track.

The light emitting unit and the light receiving unit of the first sensor unit may be disposed on a lower end surface of the housing in a predetermined shape.

In the meantime, according to an additional aspect, the serving robot may further include a second sensor unit (700).

A plurality of second sensor units may be provided along the circumferential surface of the serving robot and serves to detect an object located in the vicinity of the serving robot. The second sensor unit may include at least one of an object detection sensor and a distance detection sensor or may be a sensor including both the object detection sensor and the distance detection sensor.

The object detection sensor may include at least one of an infrared sensor, a proximity sensor, an ultrasonic sensor, and a motion sensor.

In addition, the distance detection sensor may include at least one of an infrared sensor, an ultrasonic sensor, a lidar sensor (Light Detection And Ranging, LIDAR), and a radar sensor (Radio Detection And Ranging, RADAR).

The second sensor unit may include a scanning sensor.

Unlike the technology using the line tracking algorithm, the serving robot detects the objects existed within a predetermined distance from the serving robot using the second sensor unit and moves to the destination target table using the generated 3D model.

The serving robot may further include a position measurement sensor.

The position measurement sensor may include at least one of a GPS (Global Positioning System) module, a WiFi (Wireless Fidelity) module, and an IMU (Inertial Measurement Unit) module.

The user of operating the serving robot may check the location of the serving robot in real time by using the position measurement sensor when the serving robot moves to the target table.

According to another additional aspect of the present invention, a weight measurement sensor may be provided at a predetermined position of the tray seating unit and the weight measurement sensor measures the weight of the food accommodated in the tray seating unit and provides it to the control unit.

Accordingly, the control unit (200) may control the moving speed of the serving robot based on the weight of the food.

In addition, in the serving robot according to another embodiment of the present invention, the communication function unit (110) may perform communication for its original mission, but may perform communication with other devices such as an orderer terminal and a user terminal.

Accordingly, the user may transmit an order signal to the serving robot using the user terminal.

The order signal may be a signal generated by the user terminal according to the food order of the orderer.

That is, the user may generate an order signal by using the user terminal based on the order information provided from the orderer.

The order information may include information related to ordering of food such as orderer information, ordered food information, reservation information, and orderer table information. At this time, the order signal may be a signal including the order information.

For example, a text message may also be input to the serving robot as an order signal for ordering food by using the serving robot.

In addition, a menu may be displayed on the information display unit of the serving robot and the orderer may select a food to order through the menu.

Also, the orderer may select a table located in the restaurant.

To this end, a table map of the restaurant may be displayed on the information display unit and the user may select any one of the displayed tables.

In addition, the information display unit may further display the order information, an order correction mark, a payment mark, and the staff calling mark together with the table map.

That is, the orderer can display the menu again to change the order information by using the order correction mark.

In addition, the orderer may use the payment mark to pay for food costs through the serving robot.

As such, the order signal may be generated by the user or the orderer and the order signal may be stored in a data storage unit of the serving robot.

The control unit (200) of the serving robot may determine the location of the target table to which the ordered food is delivered based on the order signal and may generate the path for the serving robot to move to the target table based on the order signal.

On the other hand, the serving robot according to another embodiment of the present invention may be further include an additional housing (510) formed in a shape surrounding the rear of the receiving unit.

The additional housing (510) prevents the foods placed on the tray seating units (140) from falling from the tray seating unit despite the sudden movement of the serving robot.

The shape of the additional housing is not limited to the shape shown in the drawings and may be formed in various shapes or structures to prevent the foods from falling from the tray seating units.

On the other hand, the serving robot according to an embodiment of the present invention can be used for serving, but it can also be used in a service process performed at the restaurant or a separate process for service provision (for example, a process for employees to dispose of garbage or move delivered goods to the restaurant).

In addition, the serving robot according to an embodiment of the present invention is not limited to a specific field such as service provision and can be utilized when the object is to be transported in various industrial fields.

That is, the serving robot according to an embodiment of the present invention is not limited to the purpose of use for serving in the restaurant.

For example, the serving robot may be used for serving during business hours of the restaurant, but may also perform cleaning tasks after business is over.

In addition, the serving robot may go out of the restaurant to attract customers and perform promotional work.

The cleaning function or the promotion function may be implemented by additionally mounting an additional cleaning module, a display module, a speaker module, or the like.

In addition, according to an additional aspect, it is characterized in that the serving robot further include an additional module (520) for performing functions other than serving, which is detachably mounted on the body of the serving robot body.

For example, if the additional module includes a display panel, after attaching it to the serving robot body, an advertisement image or a promotional image can be displayed.

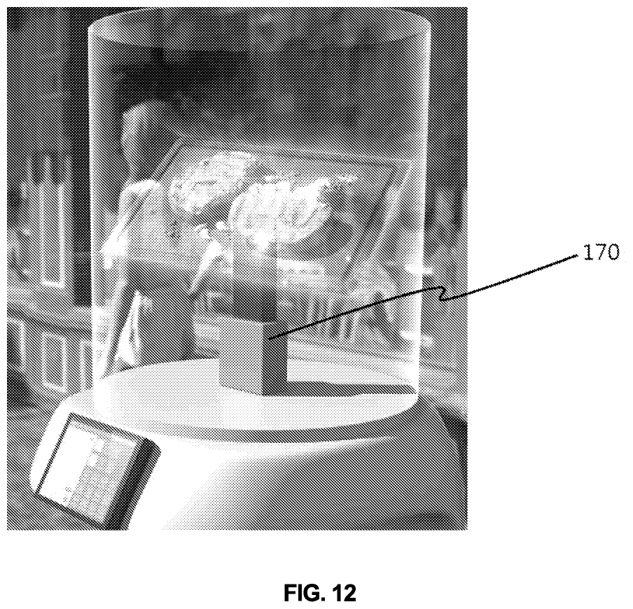

In addition, as shown in FIG. 12, according to another additional aspect, the serving robot may be configured to further include a hologram display unit (170) capable of displaying the promotional video play as a hologram image.

That is, by configuring the hologram display unit (170) at the top of the housing (500) for advertisement or promotion, the contents that the store owner (restaurant president) wants to advertise as a hologram are outputted, so that the advertisement or promotion effect can be maximized.

For example, if an advertisement or promotional video for a new menu is provided indoors or outdoors as a holographic video, when the customers see this, they come to the restaurant and think about what to order, so that it can provide an immediate effect.

Although it is not shown, for the same purpose, in order to allow the serving robot to perform other functions, some or all of the components provided for serving can be separated from the serving robot in a module form. Instead, it is possible to easily utilize the serving robot for multiple purposes by mounting the necessary components to perform other functions in the form of a module.

Specifically, it can be utilized as a cleaning robot, a crime prevention robot, a transport robot, an advertisement robot, and the like.

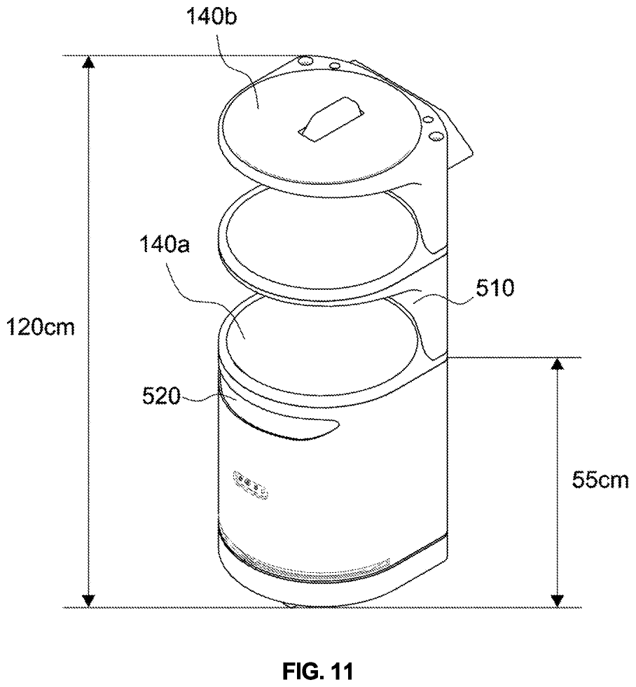

On the other hand, as shown in FIG. 11, in the tray seating units (140), it is characterized in that the position (height) of the tray from the floor to the tray (tray seating unit) is 55 centimeters to 120 centimeters.

In other words, this is the height capable of providing the most comfortable service from the perspective of customers or staffs who provide the service.

In addition, through this, the effects such as machine stability, customer convenience, kitchen workability, appearance demonstration, etc. are provided.

In order to prove the most optimal conditions as described above, the sensory evaluation of the tray (tray seating unit) height was performed according to the following conditions and it calculated the most optimal height range based on this.

Sensory Evaluation of Tray Seating Unit Height According to Conditions

This evaluation is a sensory evaluation of 550˜1200 mm as an effective height, and through this, it is intended to prove the salience of the effect.

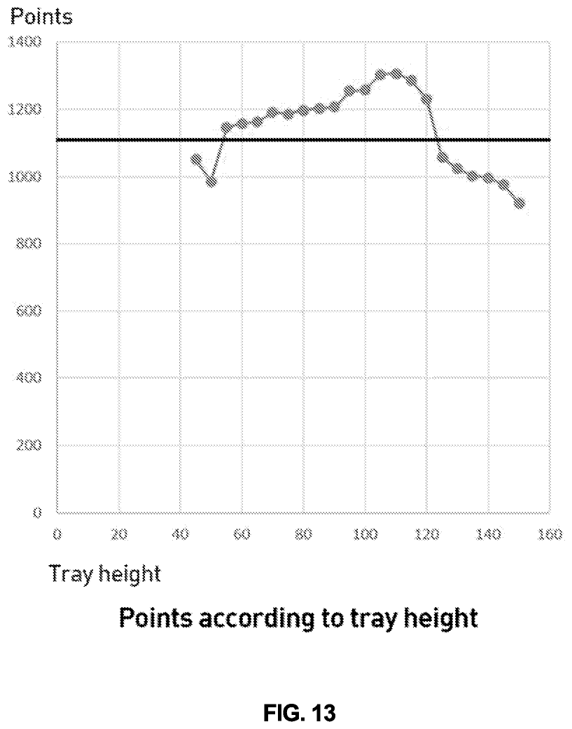

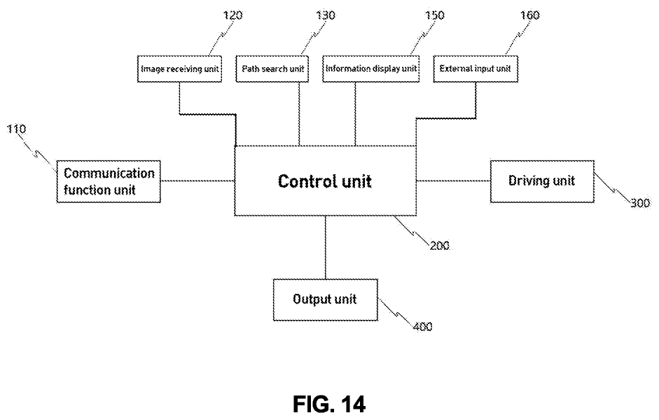

In this experiment, the mechanical stability, the customer convenience, the kitchen workability, the overall appearance for the height condition of the tray (tray seating unit) of the serving robot (40 to 150 centimeters in centimeters and 24 sections at intervals of 5 centimeters) was evaluated. A five-point scale method (very good: 5 points, good: 4 points, average: 3 points, not good: 2 points; and very bad: 1 point) was conducted by a trained sensory agent of 30 ordinary people. In addition, weights were given according to each property. The evaluation values are shown in Table 1 below (See FIG. 13).

TABLE 1

| | machine | customer | kitchen | appearance | |
|---|---|---|---|---|---|
| Tray height | stability | convenience | workability | demonstration | Total points |
| (in cm) | weight 100 | weight 90 | weight 80 | weight 60 | (weight*points) |
| 40 | 493.3 | 198.0 | 186.7 | 178.0 | 1056.0 |
| 45 | 490.0 | 204.0 | 189.3 | 168.0 | 1051.3 |
| 50 | 460.0 | 168.0 | 189.3 | 168.0 | 985.3 |
| 55 | 453.3 | 270.0 | 210.7 | 212.0 | 1146.0 |
| 60 | 452.0 | 280.5 | 243.3 | 182.4 | 1158.2 |
| 65 | 453.1 | 293.4 | 238.2 | 178.6 | 1163.3 |
| 70 | 454.6 | 332.3 | 231.5 | 173.7 | 1192.1 |
| 75 | 432.0 | 345.0 | 234.4 | 175.8 | 1187.2 |
| 80 | 429.1 | 385.4 | 219.3 | 164.4 | 1198.2 |
| 85 | 418.2 | 396.2 | 222.1 | 166.6 | 1203.1 |
| 90 | 411.8 | 402.1 | 225.3 | 169.0 | 1208.2 |
| 95 | 401.2 | 404.5 | 256.9 | 192.7 | 1255.3 |
| 100 | 397.2 | 403.5 | 261.5 | 196.1 | 1258.3 |
| 105 | 394.2 | 414.2 | 283.2 | 212.4 | 1304.0 |
| 110 | 387.6 | 410.2 | 290.5 | 217.9 | 1306.2 |
| 115 | 376.2 | 367.2 | 311.2 | 233.4 | 1288.0 |
| 120 | 374.2 | 353.2 | 287.3 | 215.5 | 1230.2 |
| 125 | 321.2 | 297.3 | 250.7 | 188.0 | 1057.2 |
| 130 | 302.1 | 287.3 | 247.9 | 185.9 | 1023.2 |
| 135 | 284.0 | 273.1 | 254.2 | 190.7 | 1002.0 |
| 140 | 272.3 | 265.8 | 261.8 | 196.3 | 996.2 |
| 145 | 265.1 | 248.8 | 263.7 | 197.7 | 975.3 |
| 150 | 254.1 | 223.5 | 253.0 | 189.7 | 920.3 |

Referring to Table 1 and FIG. 13, it can be seen that the top and bottom of the total points are significantly different from each other based on 1140 points.

That is, since the range of the tray height from 55 centimeters to 120 centimeters is the reference line, so this range is suitable as the height of the tray.

Therefore, as shown in FIG. 11, when configuring two tray seating units, the first tray seating unit (140a) is formed at a height of 55 centimeters from the ground and the second tray seating unit (140b) is formed at a height of 120 centimeters from the ground.

In addition, it is a self-evident fact that one or more positions of the tray seating units (140) can be installed and configured within the range of 55 centimeters to 120 centimeters, and the interval between the tray seating units (140) can be freely adjusted within the above range.

Through this, the effects such as the machine stability, the customer convenience, the kitchen workability, and the appearance demonstration thereof are provided.

Through the present invention, by providing the restaurant service robot, which moves to the target table along the movement path in a state in which a plurality of trays, on which food can be placed, are arranged to be vertically spaced a predetermined distance apart from each other to form a multi-layer structure and food is accommodated on the trays, so as to induce, through a voice or a display, a customer to take the food, unmanned general restaurants are possible, and a labor cost saving effect, a service quality improvement effect, and the like are provided.

In addition, in the case of the tray seating unit configured in the serving robot, the tray position (height) from the floor to the tray is 55 centimeters to 120 centimeters, thereby providing effects such as the machine stability, the customer convenience, the kitchen workability, the and appearance demonstration.

As described above, the present invention is not limited to the described embodiment, and it is obvious for those who have common knowledge in the art to variously modify and change the present invention without departing from the idea and the scope of the present invention.

Hence, since the present invention can be realized as various embodiments without departing from the technical idea or the major feature, the embodiments of the present invention are only provided as simple examples and are not to be construed narrowly but can be variously modified.

### INDUSTRIAL APPLICABILITY

According to the present invention, by providing a restaurant service robot, which moves to a target table along a movement path in a state in which a plurality of trays, on which food can be placed, are arranged to be vertically spaced apart at a predetermined distance from each other to form a multi-layer structure and food is accommodated on the trays, so as to induce, through a voice or a display, a customer to take the food, it can widely available in the field of an unmanned serving.

1. A restaurant service robot, comprising:
a communication function unit (110) for connecting to communicate with nearby Wi-Fi or Bluetooth;
an image receiving unit (120) for receiving an image of a closed circuit through the communication function unit to search for a traveling path;
a path search unit (130) that configures a movement path for distinguishing a dining table from a passage by extracting an outline of the received image to travel in the restaurant;
one or more tray seating units (140) configured to be installed on the robot; and
an information display unit (150) positioned at an upper end of the robot to display information;
an external input unit (160) for receiving an external input by configuring a touch sensor in the information display unit of the robot or by installing a button near the information display unit of the robot;
a control unit (200) for generating a control signal for moving the restaurant service robot to a target table;
a driving unit (300) for moving the robot based on the control signal; and
an output unit (400) that operates to deliver the food to the target table,
wherein a plurality of the tray seating units (140) having a multi-layer structure is arranged to be spaced apart from each other at a predetermined distance within the range of 55 centimeters to 120 centimeters from a floor to a tray so as to accommodate food;
the tray seating units of the multi-layer structure are connected through at least one or more pillars (141), which are disposed on the left, right, and rear of the tray seating units (140), so that an upper space of the tray seating units (140) is open to a front thereof;
a housing (500) is provided at a lower portion of the tray seating unit of the lowest layer among the plurality of tray seating units and a steering unit and a transfer unit for moving the robot in contact with the floor are disposed at the lower end portion of the housing; and
an additional module (520) for performing functions other than serving is detachably mounted on a body of the robot, so that it can be utilized as any one of a cleaning robot, a crime prevention robot, a transport robot, and an advertisement robot.

2. (canceled)

3. (canceled)

4. The restaurant service robot according to claim 1, further comprising:
a hologram display unit (170) that can display a promotional image play as a hologram.

5. The restaurant service robot according to claim 1,
wherein the external input unit further includes a touch pad.
